(19) United States
(12) Patent Application Publication
(10) Pub. No.: US 2023/0133275 A1
(43) Pub. Date: May 4, 2023

(54) HEARING AID EAR TIP HAVING SAFETY CONNECTOR

(71) Applicant: Daniel R. Schumaier, Elizabethton, TN (US)

(72) Inventor: Daniel R. Schumaier, Elizabethton, TN (US)

(21) Appl. No.: 17/518,621

(22) Filed: Nov. 4, 2021

(51) Int. Cl. H04R 25/00

(52) U.S. Cl. CPC H04R 25/556; H04R 25/652; H04R 25/607

(57) ABSTRACT

An ear tip assembly is used with a hearing aid thin tube or with a receiver wire attached to an in-the-canal receiver. The ear tip assembly includes an ear tip and safety connector. The ear tip can be removably seated on the thin tube connector or to a post on the in-the-canal receiver. The safety connector prevents the ear tip from remaining lodged in the ear canal if the ear tip detaches from the thin tube connector or the receiver. The safety connector includes a lanyard and a loop. One end of the lanyard is secured to the ear tip and the other end is secured to the loop. The loop receives the thin tube or the receiver wire so as to prevent detachment of the safety connector from the thin tube or the receiver wire when the thin tube or the receiver wire is pulled from the ear canal.

### RELATED APPLICATIONS

None

### FIELD

This invention relates to the field of hearing aids. More particularly, this invention relates to a safety connector system for hearing aid ear tips.

### BACKGROUND

Ear tips—also sometimes referred to as “domes”—for hearing aids are small, bell-shaped or mushroom-shaped silicone pieces that fit on the end of hearing aid tubing (aka thin tubes) and are inserted deep into the ear canal. They come in different shapes and sizes to accommodate the unique twists, turns and size of each individual's ear canal. Ear tips typically attach to the thin tubes of behind-the-ear (BTE) styles of hearing aids, or they attach directly to the receivers of receiver-in-canal (RIC) or receiver-in-the-ear (RITE) styles of hearing aids.

There are various configurations of ear tips that can be attached to the receiver or thin tube. Often these tips need to be removed by the consumer for cleaning or replaced by the consumer because of wear. Many hearing aid consumers are older with poor finger dexterity, and they often do not get the tips properly seated on the receiver or thin tube. When ear tips are not properly seated, they can become detached and stuck in the ear canal.

Typically, the removal of detached tips from within the ear canal requires the services of an audiologist, an ear, nose and throat (ENT) doctor, or other professional. Sometimes detached tips are lodged against the eardrum and must be removed under a surgical microscope. Thus, the problem: when the thin tube or receiver is removed from the ear canal, the improperly-seated tip can detach and remain in the ear canal, thereby requiring a trip to the professional for removal.

What is needed, therefore, is a simple and reliable system for allowing the hearing aid user to retrieve a detached ear tip from the ear canal.

### SUMMARY

The above and other needs are met by an ear tip assembly for use with a hearing aid of a type that includes either a thin tube with a thin tube connector or a receiver wire attached to an in-the-canal receiver. In a preferred embodiment, the ear tip assembly includes an ear tip that is inserted into the ear canal of the user and a safety connector attached to the ear tip. The ear tip is configured to be removably attached to the thin tube connector or to a post on the in-the-canal receiver. The safety connector prevents the ear tip from remaining lodged in the ear canal in case the ear tip detaches from the thin tube connector or from the post on the in-the-canal receiver. In a preferred embodiment, the safety connector comprises a lanyard and a loop. The lanyard has a first end secured to the ear tip and a second end secured to the loop. The loop is configured to receive the thin tube or the receiver wire within the loop so as to prevent detachment of the ear tip assembly from the thin tube or the receiver wire when the thin tube or the receiver wire is pulled from the ear canal.

In some embodiments, the loop is formed of elastic material that will allow the loop to stretch sufficiently to slide over the thin tube connector to receive the thin tube within the loop, or to slide over the in-the-canal receiver to receive the receiver wire within the loop.

In some embodiments, the ear tip, the lanyard and the loop are integrally formed from a single material, such as silicone.

In some embodiments, the lanyard and loop are formed of metal wire with an opening in the loop into which the thin tube or the receiver wire may be inserted. In other embodiments, the lanyard and loop are formed from monofilament line, such that the thin tube or the receiver wire may be inserted into the loop and a slipknot will cinch down to hold the loop in place. Alternatively, a metal ring may be attached to the end of the monofilament line, with a break in the loop for receiving the thin tube or the receiver wire.

In some embodiments, the ear tip comprises an ear mold, an open dome, a closed dome, a power dome, or a sleeve.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts a receiver-in-canal (RIC) hearing aid receiver and wire, with no ear tip attached thereto;

FIG. 2 depicts an ear tip assembly having a safety connector according to a preferred embodiment;

FIG. 3 depicts an RIC hearing aid receiver and wire, with a safety connector of an ear tip assembly attached to the wire according to a preferred embodiment, and the ear tip detached from the receiver;

FIG. 4 depicts an RIC hearing aid receiver and wire, with a safety connector of an ear tip assembly attached to the wire according to a preferred embodiment, and the ear tip attached to the receiver;

FIG. 5 depicts a thin tube for a behind-the-ear (BTE) hearing aid, with a safety connector of an ear tip assembly attached to the thin tube according to a preferred embodiment, and the ear tip detached from the end of the thin tube; and

FIG. 6 depicts various embodiments of an attachment loop of a safety connector for an ear tip;

FIG. 7A depicts an attachment loop of a safety connector for an ear tip having a slipknot configuration according to a preferred embodiment; and

FIG. 7B depicts the attachment loop of FIG. 7A attached to a receiver wire according to a preferred embodiment.

### DETAILED DESCRIPTION

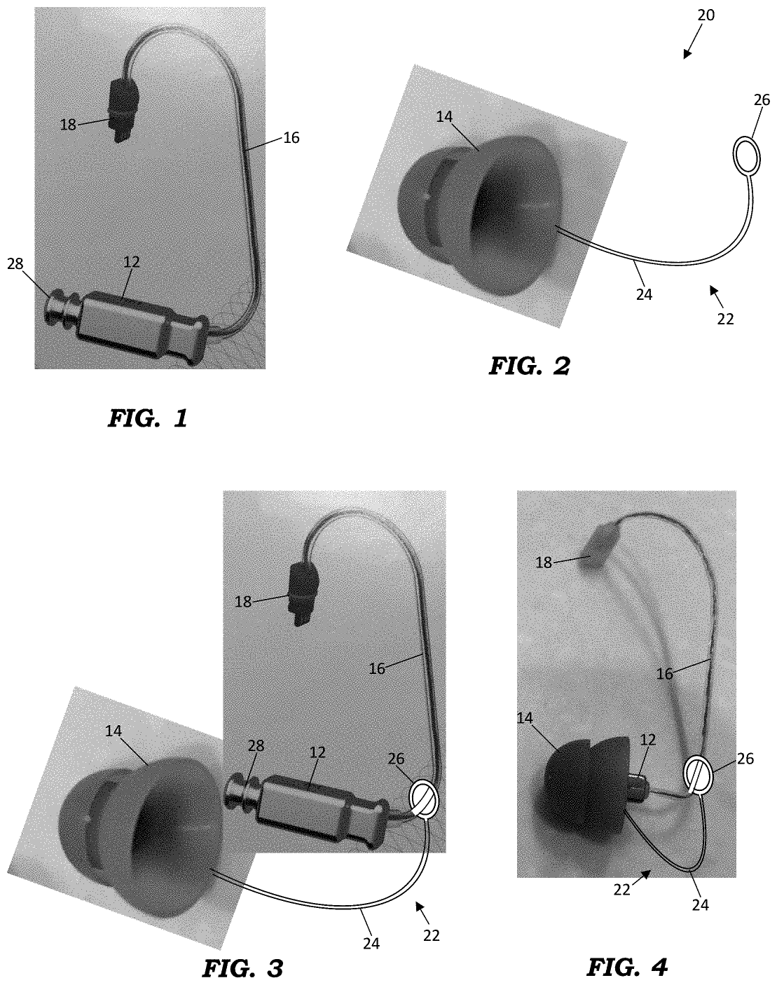

FIG. 1 depicts a typical receiver-in-canal (RIC) hearing aid receiver 12 and wire 16, with a connector 18 that provides electrical connection between the wire 16 and a hearing aid (not shown). A ribbed post 28 on the receiver 12 provides for the attachment of an ear tip to the receiver 12.

FIG. 2 depicts an ear tip assembly 20 that includes an ear tip 14 and a safety connector 22. The safety connector 22 includes a lanyard 24 and a loop 26 connected to one end of the lanyard 24. The other end of the lanyard 24 is connected to the ear tip 14. In a preferred embodiment, the ear tip 14 and the safety connector 22 are integrally formed from silicone as a one-piece structure, such as by injection molding. In an alternative embodiment, the lanyard 24 of the safety connector 22 is attached to the ear tip 14 using an adhesive.

In other embodiments, the lanyard 24 and loop 26 of the safety connector 22 are formed from monofilament line, and the end of the lanyard 24 is sutured into the silicone material of the ear tip 14. In another embodiment, the loop 26 may be a metal ring attached to the end of the monofilament line.

In yet another embodiment, the lanyard 24 and the loop 26 of the safety connector 22 are formed from wire, and the lanyard 24 is attached to the ear tip 14 using adhesive or a small barb or hook that embeds into an inside surface of the ear tip 14.

In various embodiments, the ear tip 14 may be an ear mold, an open dome, a closed dome, a power dome, or a sleeve.

As shown in FIG. 6, the loop 26 of the safety connector 22 may have different configurations for different applications. In a first embodiment, the loop 26a is a continuous annular ring. In a second embodiment, the loop 26b has a more solid structure with a central slit. The loops 26a -26b of the first and second embodiments are preferably formed from silicone or other elastic material that will allow the loops 26a -26b to be stretched somewhat as described hereinafter. In a third embodiment, the loop 26c is formed from spring-like wire that has a break for allowing the loop 26c to be opened for installation around a receiver wire or thin tube.

As depicted in FIG. 3, prior to attachment of the ear tip 14 to the receiver 12, the loop 26 of the safety connector 22 is stretched around either the receiver 12 or the connector 18 so that the loop 26 can slide onto the wire 16. The ear tip 14 may then be pressed onto the post 28 of the receiver 12, resulting in the assembled configuration shown in FIG. 4.

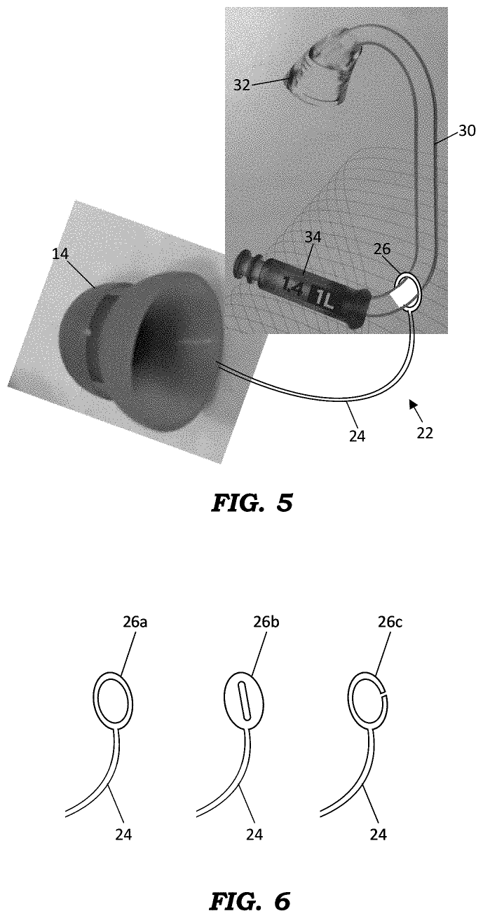

FIG. 5 shows the safety connector 22 attached to a thin tube 30 for use with a behind-the-ear (BTE) hearing aid. In this case, the loop 26 of the safety connector 22 is stretched around either the thin tube connector 34 or the adapter 32 so that the loop 26 can slide onto the thin tube 30. The ear tip 14 may then be pressed onto the post of the thin tube connector 34.

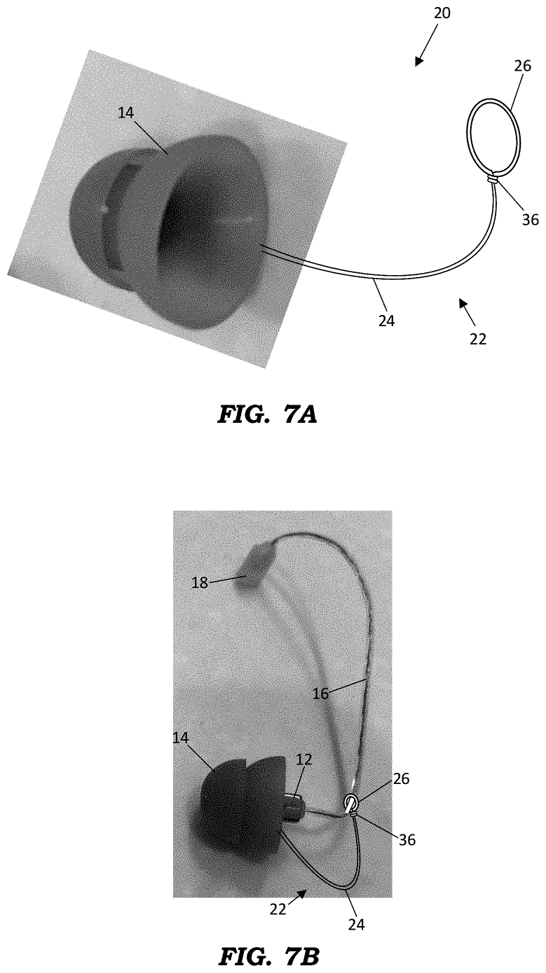

In an alternative embodiment of the ear tip assembly 20 shown in FIG. 7A, the lanyard 24 and loop 26 are formed from monofilament line, and the diameter of the loop 26 may be adjusted by use of a slipknot 36 in the line. In this embodiment, the thin tube connector 34 or the receiver 12 may be inserted through the enlarged loop 26, and then the line can be cinched down to reduce the diameter of the loop 26. As shown in the RIC embodiment of FIG. 7B, the cinched-down loop 26 secures the ear tip assembly 20 onto the receiver wire 16. As the term is used herein, a slipknot is any device that allows for pulling the line that forms the lanyard 24 to reduce the diameter of the loop 26.

In another embodiment, the loop 26 is a small metal ring that does not attach directly to the thin tube 30 or wire 16. In this embodiment, if the ear tip 14 becomes disconnected from the receiver 12 or the thin tube connector 34 and remains lodged in the ear canal, the loop 26 can be grabbed using a tweezer at the end of a curette or using a hook curette, so that the whole ear tip assembly 20 may be pulled out of the ear canal.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An ear tip assembly for use with a hearing aid, wherein the hearing aid includes either a thin tube with a thin tube connector or a receiver wire attached to an in-the-canal receiver, the ear tip assembly comprising:
an ear tip configured to be removably attached to the thin tube connector or to a post on the in-the-canal receiver, and to be inserted into an ear canal of a user; and
a safety connector for preventing the ear tip from remaining lodged in the ear canal in case the ear tip detaches from the thin tube connector or from the post on the in-the-canal receiver, the safety connector comprising:
a lanyard formed of metal wire having a first end and a second end, wherein the first end of the lanyard is secured to the ear tip; and
a loop formed of metal wire secured to the second end of the lanyard, wherein the loop has a break therein into which the thin tube or the receiver wire may be received,. the loop surrounding a portion of the thin tube that is received within the loop, or surrounding a portion of the receiver wire that is received within the loop, so as to prevent detachment of the ear tip assembly from the thin tube or the receiver wire when the thin tube or the receiver wire is pulled from the ear canal.

2. (canceled)

3. (canceled)

4. (canceled)

5. The ear tip assembly of claim 1 wherein the ear tip comprises an ear mold, an open dome, a closed dome, a power dome, or a sleeve.

6. (canceled)

7. (canceled)

8. The ear tip assembly of claim 1 wherein the first end of the lanyard is attached to the ear tip using an adhesive or a suture.

9. (canceled)

10. A hearing aid assembly comprising:
a hearing aid that includes either a thin tube with a thin tube connector or a receiver wire attached to an in-the-canal receiver having a post;
an ear tip comprising an ear mold, an open dome, a closed dome, a power dome, or a sleeve, the ear tip removably attached to the thin tube connector or to the post on the in-the-canal receiver; and
a safety connector for preventing the ear tip from remaining lodged in the ear canal in case the ear tip detaches from the thin tube connector or from the post on the in-the-canal receiver, the safety connector comprising:
a lanyard having a first end and a second end, wherein the first end of the lanyard is secured to the ear tip; and
a loop secured to the second end of the lanyard, the loop surrounding a portion of the thin tube that is received within the loop, or surrounding a portion of the receiver wire that is received within the loop, such that the loop prevents detachment of the safety connector from the thin tube or the receiver wire when the thin tube or the receiver wire is pulled from the ear canal.

11. The hearing aid assembly of claim 10 wherein the ear tip, the lanyard and the loop are integrally formed from a single material.

12. The hearing aid assembly of claim 11 wherein the ear tip, the lanyard and the loop are integrally formed from silicone.

13. (canceled)

14. The hearing aid assembly of claim 10 wherein the lanyard and loop are formed of monofilament line.

15. (canceled)

16. The hearing aid assembly of claim 10 wherein the first end of the lanyard is attached to the ear tip using an adhesive or a suture.
